(19) United States
(12) Patent Application Publication
(10) Pub. No.: US 2018/0013975 A1
(43) Pub. Date: Jan. 11, 2018

(54) MULTIPLE DEVICE RECORDING PROCESS AND SYSTEM

(71) Applicant: Kombikam LLC, Fresh Meadows, NY (US)

(72) Inventor: Edmond Tang, Fresh Meadows, NY (US)

(21) Appl. No.: 15/647,169

(22) Filed: Jul. 11, 2017

Related U.S. Application Data
(60) Provisional application No. 62/360,619, filed on Jul. 11, 2016.

(51) Int. Cl. H04N 5/77; H04N 21/43; H04N 21/2743; G11B 27/031; H04N 21/2665; H04N 5/247; H04N 21/81; H04N 21/4223

(52) U.S. Cl. CPC H04N 5/77; H04N 21/8173; H04N 21/4307; H04N 21/4223; G11B 27/031; H04N 21/2665; H04N 5/247; H04N 21/2743

(57) ABSTRACT

A system is provided where video and audio is recorded by multiple devices, that can be played back on the same video via split frames. In an embodiment, multiple cameras and devices, for example ranging from iPhones, to Android phones, to GoPros, connected via Wi-Fi/Wi-Fi-direct to be synchronized via an app. Once all devices are ready, the master or primary device can initiate a recording on all the cameras simultaneously. Once the recording has stopped, the devices will send the video to the master device for processing and merging.

### CROSS-REFERENCE TO RELATED APPLICATION(S)

The present application claims priority to U.S. Provisional Patent Application No. 62/360,619 filed on Jul. 11, 2016, entitled “Multiple Device Recording Process and System” the entire disclosure of which is incorporated by reference herein.

### BACKGROUND OF THE INVENTION

### Description of Related Art

There exist a number of different video editing apps for phones and tablets in the market today. Some of the best video editing apps including Adobe Premiere Clip, Magisto, and WeVideo are available to both Android and iOS devices and are excellent for stitching together video clips taken or uploaded by the user himself. Some of these related arts have the ability to take video directly through the app. However these apps are lacking in their ability to connect all users of the app in order to share video footage from a specific area or point in time. Another major deficiency for many of these apps is their inaccessibility to users of different software.

Another related art would be the story feature of Snapchat. This app allows users to share live video footage based on the geographic location of the device. Examples include music festivals, sporting events, or cities. What this application lacks is the availability to edit all of these videos together or to save the videos. The videos on this app all expire after 24 hours. The videos on this app can only be taken via a smartphone or tablet and can be a maximum of 10 seconds. Videos cannot be recorded, saved, and edited via the app.

Some applications that include a social feature (the ability to share videos) include Viddy, Socialcam, Replay Video Editor, or mobile. What these video sharing apps lack still are the ability to collect videos from a number of different sources to create one video stream. These apps also lack the ability to collect videos and categorize them according to a specific geographic location or event.

Based on the foregoing, there is a need in the art for this multiple video recording process and system. While all of the above-mentioned related arts have their pros, they are lacking in that they are exclusive in their software requirements, and that videos from a variety of different camera sources cannot be uploaded. Furthermore, none of these related arts have the interactive feature of the proposed application. This app would have the ability to collect any users live or saved recordings from a particular place or event.

### SUMMARY OF THE INVENTION

A process and system are provided where a computer application is recording and controlling video and audio footage recorded from multiple devices, that can be played back on the same video via split frames. In an embodiment, multiple cameras and devices, for example ranging from iPhones, to Android phones, to GoPros, connected via Wi-Fi/Wi-Fi-direct to be synchronized via the app. Once all devices are ready, the master or primary device can initiate a recording on all the cameras simultaneously. Once the recording has stopped, the devices will send the video to the master device for processing and merging.

There are multiple playback options. A first option, would be for all videos to be played back in a single frame, but simultaneously, preferably in equal sized frames. A second option would be to use the editor to pick which frame is played as the video goes on, giving the best angle. A third would be to use the editor, and play back multiple frames, but choose which frame is the dominant frame, while the others are still playing smaller. The dominant frame would carry the audio in the cases of the second two options, while the first option would only use the audio from the master device. In a fourth option the user can swipe between the different audio and video frames from each satellite device.

The ratio of how each video is recorded, is such that the app has a set aspect ratio, based on the number of cameras and/or satellite device connected into a recording group and/or session. For example recording in squares, or some other aspect ratio to accommodate the number of devices in the system at any one time. The user is setting parameters to the recording quality to adjust for memory storage and quality requirements.

To expand on the concept on how all the devices are synchronized, the app is being downloaded to each users device. Each user will have a login, including a nickname or username to identify each different device. Each username can be watermarked or printed on the bottom of their recording as well, so playback can show who recorded what.

The foregoing, and other features and advantages of the invention, will be apparent from the following, more particular description of the preferred embodiments of the invention, and the accompanying figures.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1a-b is a flowchart of the process, according to an embodiment of the present invention; and

FIG. 2 is a flowchart of the process, according to an embodiment of the present invention.

FIG. 3 is an alternative flowchart of the process, according to an embodiment of the present invention.

### DETAILED DESCRIPTION OF PREFERRED EMBODIMENTS

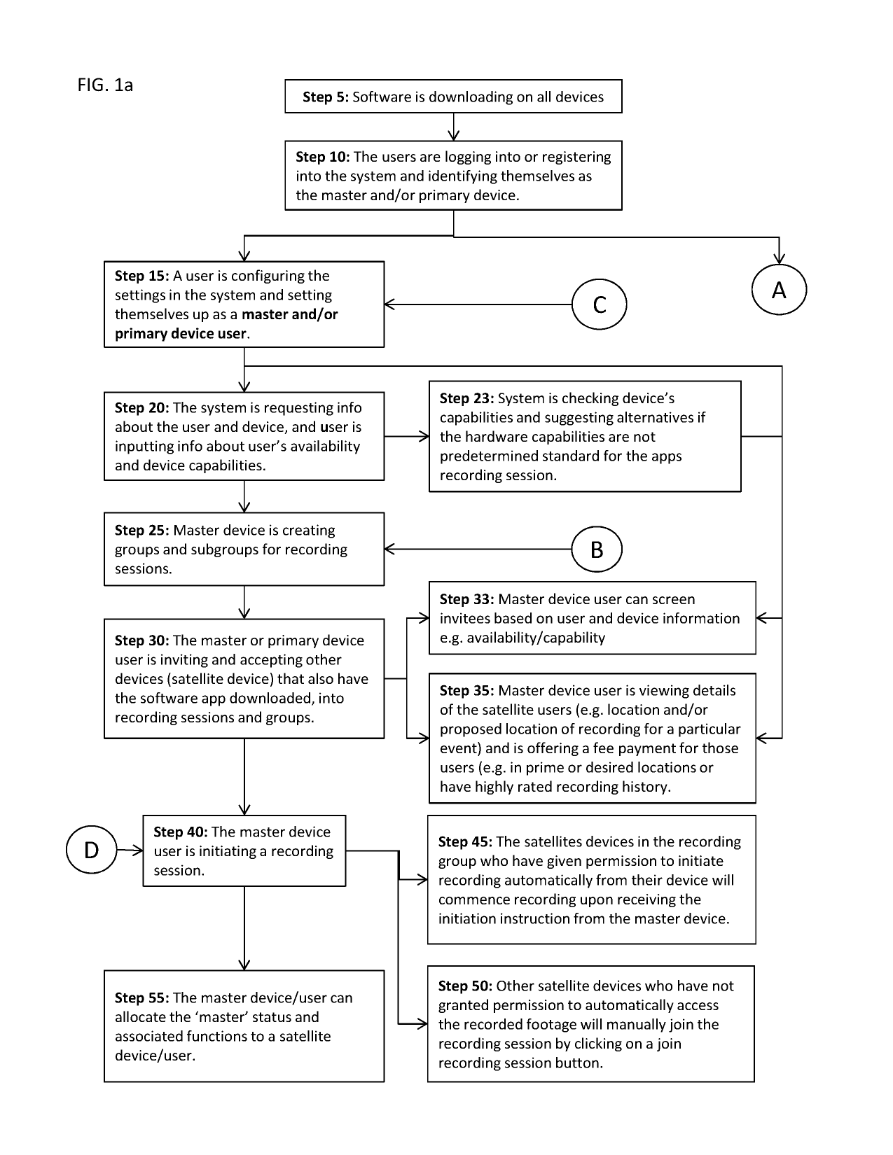

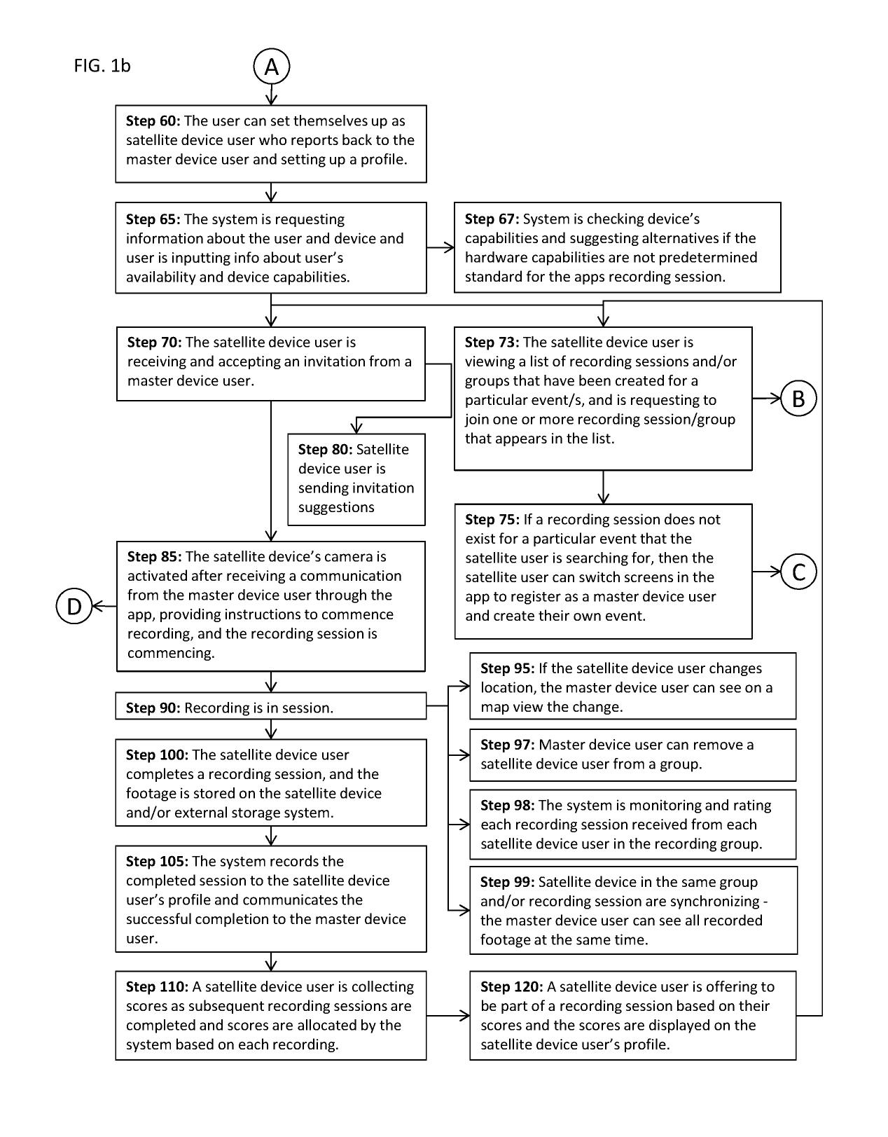

Embodiments of the present invention and their advantages may be understood by referring to FIGS. 1-3, wherein like reference numerals refer to like elements.

Process

At step 5 the users are downloading a software application to their devices. The software application controls one of more processors in order to carry out the objectives set forth herein. Devices may comprise cell phones, smartphones, laptops, GoPros, dash-cams, digital SLRs, drones, and webcams, all having cameras. At step 10 the users are logging into or registering into the system and determining if they are a master or primary device user and identifying themselves and their device as the master/primary device. Thereafter an ad-hoc wireless network is established among the devices using well-known conventional techniques. In an embodiment, a master device user can simultaneously be a satellite user, but a satellite user cannot simultaneously be a master device user, so that the navigation and control of a recording session can be controlled from a single device (preferably the master device) to avoid conflicting recording instructions such as record, resume recording stop recording merge and other related recording and editing functions.

At step 15 a user is configuring the settings in the system and setting themselves up as a master/primary device user. At step 20 the system is requesting information about the user and device in order to check, at step 23 for the device's capabilities and suggesting alternatives if the hardware capabilities are not to a predetermined standard for the apps recording session and the device user is answering the questions and inputting required information.

At step 25, the system is requesting master device user to create groups for recording sessions, name each group, provide a description for each group and enter other related information or instructions related to the recording or event.

At step 30, the master or primary device user is inviting and accepting other devices (satellite devise) that also have the software app downloaded, into recording sessions and groups. At step 33, the master device user can screen the information in the system about the users/invitees and their devices, to select invitees based on the information provided and who it suits a particular recording session. At step 35, the master device user can see details of the satellite users location and/or proposed location of recording for a particular event and is offering a fee payment for those users who are for example in prime or desired locations or have highly rated recording history.

At step 40 the master device user is initiating a recording session by clicking on a start recording button in the app. The initiation by the master device involves communicating with all the satellite devices in that particular recording group by sending instructions to the devices in that group to commence the recording session. At step 45 the satellites devices in the recording group who have given permission to initiate recording automatically from their device, will commence recording upon receiving the initiation instruction from the master device user. At step 50 other satellite devices that have not granted permission to automatically access the recorded footage will manually join the recording session by clicking on a join recording session button, when they receive an alert from the master device user indicating that the recording session will commence soon and then again when the session has commenced.

In an embodiment, at step 55 the master device/user can allocate their master user status to another satellite user during the recording session and/or streaming if for example a change in user control is required/desired.

At step 60 the user is a satellite device user and may create a profile and registering their details in the system. The satellite device and user report back to the master device and user. At step 65 the satellite device user is inputting information such as device capabilities, user's recording availability and flexibility, which events they would like to join, an event and/or group that they will be attending, free lance recorder, device capabilities, recording time preferences, status updates, automatic access permission and frequency of attending certain types of events. This information is stored in the system and is viewable by a master device user. At step 67, the system is checking the device's capabilities and suggesting alternatives if the hardware capabilities are not predetermined standard for the apps recording session.

At step 70 the satellite device user is accepting and invitation from a master device user and/or at step 73, joining a recording session that appears in a list of recording sessions on the app. The satellite user can search for an event that they will be attending to determine if a recording session and/or group has been created for that particular event. In an embodiment, at step 75 if a recording session does not exist for a particular event that the satellite user is searching for, then the satellite user can switch screens in the app to become a master device user and create their own event, then proceed to use all the functions that are available to a master device user and their device becomes tagged as a master device. At step 80 if the satellite device user is accepted by a master device user to join a particular recording session/group, then the satellite device user can send invitation suggestions to other potential satellite users to join the recording session, pending master device users approval.

In an embodiment, the system synchronizes the start time of multiple cameras. In an embodiment, Network Time Protocol (NTP) may be used to synchronize the clocks of the individual cameras. The AWS server provides a central time signal, overriding the device clock, to avoid the case where multiple device may each have their own time signal, often seconds or more apart. The initiator who initiates the call and selects friends and initiates the video chat for recording. The signal may be sent to each of the invited parties, to accept, reject, or time out. The video recording is suspended on all invited devices until the last signal accepts, rejects or times out on the group recording session.

At step 85 the satellite device's camera is activated after receiving a communication from the master device user through the app providing instructions to commence recording based on permission settings as registered by the invited satellite user. The recording session is commencing and the system is recording the footage on a CPU register and/or external storage device and/or system.

At step 90, the recording session is in progress and the satellite devices are recording footage and audio, and other devices are joining in as the session time progresses. During the recording session, the satellite device user is recording footage from a specific location and the location is being recorded and monitored by the system via GPS communication.

At step 95 if the satellite device user changes locations during the recording session, the app is monitoring the change of location through GPS and reporting back to the system and the master device user can see on a map view the change. The system may geotag the location of the video, also to verify that the video source is on-site. In further embodiments, the location and the direction of the video source may be recorded and provide to the server, so that the viewpoint of the particular device is known and shareable. At step 97, during the recording session, a master device user can delete or remove a satellite user if the recorded data is not desired. At step 98, the system is monitoring and rating each recording session received from each satellite device user in the recording group.

At step 99 satellite device users who are in the same group and/or recording session, have their devices synchronized, so that during playback, the master device user can see all recorded footage at the same time to allow for any small time differences.

At step 100 the satellite device user completes a recording session, from for example time 0 s to 10 min, and the footage is stored on the satellite device and/or external storage system.

At step 105 the system records the completed session to the satellite device user's profile and communicates the successful completion to the master device user.

At step 110 all satellite device users in the recording session have their recording footage rated by the system based on parameters such as quality of footage, obstructions to view, audio, lighting, location, perspective, highlight capturing and a rating is allocated based on each parameter to provide an overall score and/or rating for the satellite device user. At step 115 a satellite device user is collecting scores as subsequent recording sessions are completed and scores are allocated by the system based on each recording.

At step 120 a satellite device user is offering to be part of a recording session based on their scores and the scores are displayed on the satellite device user's profile so that master device users can see the rating and extend invitations to selected satellite device users according to rating in order to achieve better quality footage.

At step 130 the master device user is accessing and playing back the recorded footage from the satellite devices in a recording session group, by extracting recorded footage data from a CPU register or some other form of memory locations/storage media. At step 135 the master device user is choosing different playback options such as single frame, dominant frame or all frames. At step 140 the master device user is extracting recorded footage data from a CPU register or some other form of memory locations/storage media, editing and storing the recorded footage on a database or external storage system.

System

The system has devices, for example but not limited to multiple cameras, mobile devices that have cameras, for example iPhones™, Android™ phones and other smart phones/devices, camera devices such GoPros™, any device that has a camera and software capabilities and/or the ability to attach to a device that has software. In a preferred embodiment the devices are hand held mobile smart phones that have the software application downloaded onto the device by a user.

The system operates with at least one power source, one or more processors, a storage media device location, one or more algorithms to account for unique identification of the user and device (frequency, selections, activity, event) of special features, special functions and editing functions, and various locations, one or more optical receiving devices such as a camera, and one or more information input platforms such as a keyboard or touch screen. The system has a software application and/or app that is downloaded onto each device, primary, secondary, master, satellite and any other device that is part of the system group and/or system.

The software application on each device is recording visual and/or audio footage, playing back, synchronizing and splitting screens according to each satellite device.

In an embodiment, the system has one or more but at least one devices that are secondary and/or satellite devices. In an embodiment, the system has one or more but at least one devices that are primary and/or master devices. In an embodiment, during the registration and set up process of the app, the user is able to set up their device as either a master device or satellite device but not both.

In an embodiment, a user is set up as a master device user and is inviting, allowing and accepting the addition of particular satellite devices into the system or system group using the app that is downloaded on their device. In an embodiment, a system group, recording group, and/or event group can be set up by the master device user to manage and organize the allocation of particular satellite device users into particular groups based on the desired outcomes for a particular recording session. The master device user can name the group, for example foot ball grand final or friend's wedding. The master device user can also create sequential recording sessions/groups within each system group such that for example: a selected number of satellite users can be allocated to each recording session, a selected number of the same satellite users from a recording session can be allocated to different recording sessions, the satellite users from one group can be allocated into other groups and/or other recording sessions. In an embodiment, the master device user can drag and drop satellite users from a preexisting list of attendees into created groups.

In an embodiment, the system has a preexisting list of users who have indicated through the registration process that they would like to be invited to particular recording sessions for a particular event. For example, prior to a sporting event, users who have downloaded the app register they want to included in any recording session/s or group/s that relate to the event. In embodiment, these users appear in the system with a status reading “ready to invite” or “attending and ready to record” or “seated—ready to record”. Other status messages can be customized based on the event giving the master user information about who to include in various recording session and at what time. In an embodiment, the master device user can copy, move, drag and drop satellite users from the preexisting list of attendees, according to status information, into the groups and sub-recording sessions that the master device user has created.

In an embodiment, the master device user can see a symbolic map of the satellite users' locations and video direction/viewpoints, represent by for example color coded symbols, where each color represents ready to record in green or not yet available in grey, creating a layout of the users that the master device user has access to for recording during a particular event. Each symbol represents a satellite user and device, and is linked to the satellite users profile so that the master device user can also copy, move, drag and drop the symbols into recording groups.

In an embodiment, the devices are simultaneously recording footage from the angle at which they are located. For example, in a stadium, there can be multiple users registered as satellite and master devices located any position within the stadium, each user having a different angle, elevation, lighting, and distance to the even that they are recording. A viewer streaming the videos may then switch, in synchronicity across the views, such that a viewer may see an event from multiple viewpoints just by swiping back and forth between views.

In an embodiment, all devices are recording simultaneously during a given time frame as controlled by the master device. For example, the master device initiates a recording session, at time 0 s and activates all satellite devices to commence recording, then the master device user sends the recording at for example time 10 minutes. In this example all the devices, including the master device, are recording footage simultaneously so that there is zero to minimal time delay between the footage being recorded by each of the devices that are in a particular the group.

In an embodiment, the master device is able to create multiple groups and invite selected satellite devices into each group. For example, for a more lengthy sporting event, the master device might invite users who are outside the stadium into a group they might call pre game, and the master device user is controlling when to initiate and end various recording session during the pre game period showing fans on the outside or at other locations such as pubs or sporting bars who are also watching the event. Then the master device user is creating a different group and might call it first quarter, second quarter, third quarter, post game. The master device user can allocate satellite device users into each group based on the particular event's anticipation (e.g. star players, goal location), satellite device's capabilities (e.g. battery and storage capabilities) allowing for highlights of an event to be recorded in selected and/or entire segments by different satellite and master users in each group, to spread out the recording load and allow for a significant permutations and combinations of the possible perspective views as recorded by each device.

In an embodiment the master device is automatically initiating the recording session with permission to do so granted by the satellite device user during the registration and joining process. An automatic initiation of a recording session by the master device user ensures that the recording session is not jeopardized by late joiners or forgetful users. In an embodiment, the device users can choose not to give permission for the master device to automatically initiate a recording on their device. In particular embodiments, users are categorized based on permission granted and a master device user can prioritize those who do give automatic permission so that the recording session is run in an optimal manner. In other embodiments, device users can join into the recording session at any time after the master device user has initiated the session and during the time when the session is active.

In an embodiment, the devices are live streaming footage that is being recorded by each device to the master device. In an embodiment, the devices are recording and storing the recorded footage onto their individual device. When the recording session ends and/or is ended by the master device user, the stored footage is sent to the master device. The master device user is receiving the recorded footage from the satellite devices and playing the recorded footage on the master device. In an embodiment, the user of the master device is receiving and viewing multiple screens that correspond with each satellite device's recording, either via live streaming and/or stored and sent by the satellite users device. In an embodiment, the master device user is playing back the footage received from the devices.

In an embodiment, the devices in the system each have a unique identifier number that are allocated to the device and/or user at the time that the software application is downloaded onto the device. The ID numbers allow the software to track and monitor the devices involved in the system and detect if for example a device has left a recording session, joined a recording session and other function that require tracing and reporting in order to link which device is doing certain activities.

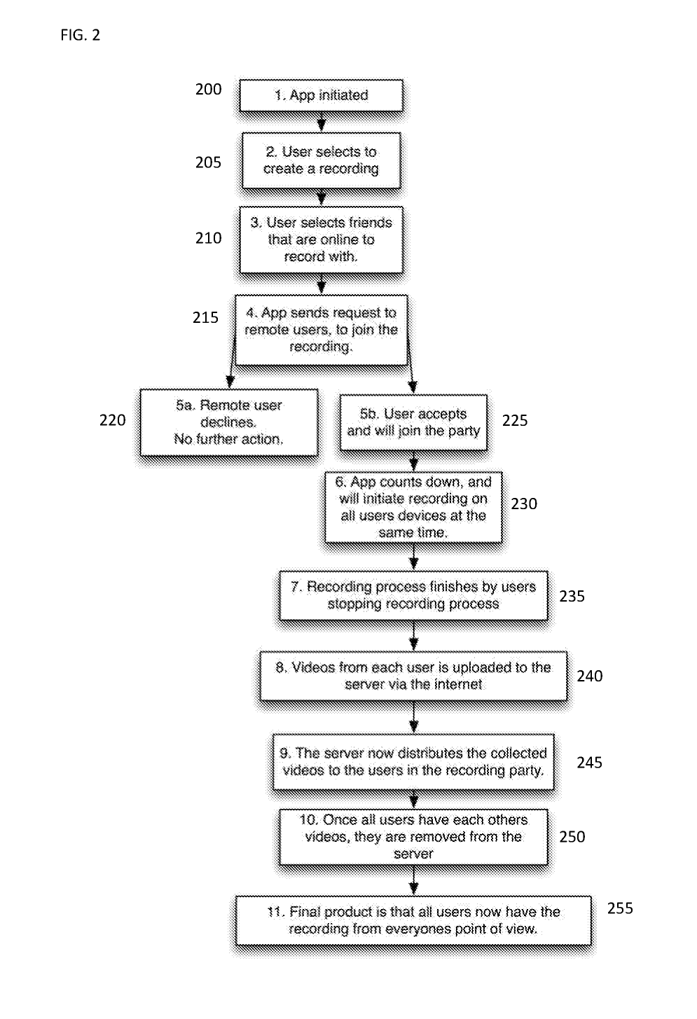

In an embodiment, FIG. 2 illustrates the playback viewing, controlling and editing options for the master device user. In step 200, the app is initiated, and in step 205, the user selects to create a recording. In step 210, the user selects friends that are online to record with. In step 215, the app sends a request to remote users, to join the recording. in step 220 the remote user declines, and no further action is taken. In step 225, on the other hand, the user accepts and will join the party. In step 230 the app counts down (synchronizes), and initiates recording on all user devices simultaneously. In step 235, the recording stops when the user selects to stop the recording process by user input. In step 240 videos from each user are uploaded to the server via the Internet. In step 245, the server distributes the collected videos to the users in the recording party. In step 250, once the users have each other's videos, they are removed from the server. In step 255, the final result is that all users have the recording from every other users' point of view.

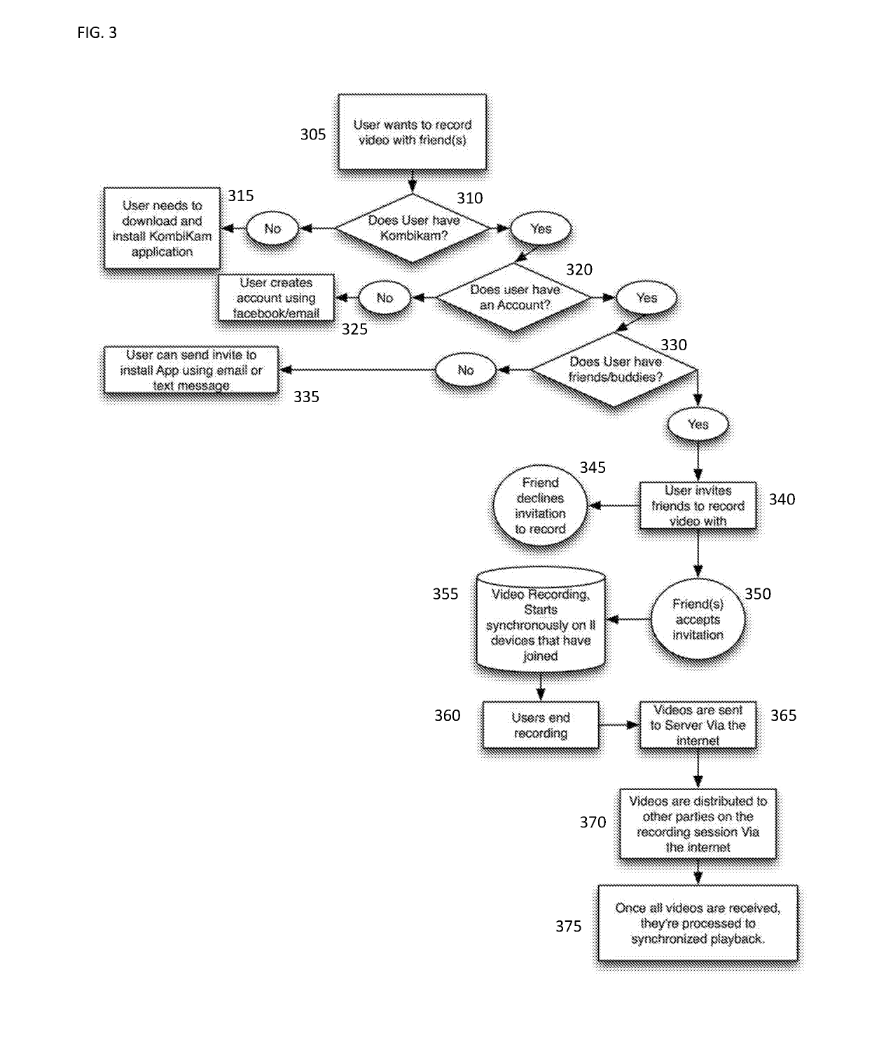

With reference to FIG. 3, an alternative embodiment of the process is shown. In step 305, the user wants to record video with friends. In step 310, if the friends do not have the system, they can download and install it as step 315. If they do have it, they can log in to an existing account at step 320 or set up and account at step 325. At step 330, the user adds friends, and can invite them or additional friends at step 335. At step 340, the user invites friends to record video with, and in step 345, one or more friends may decline an invitation to record. In step 350 friends accept invitations, and in step 355, the video starts recording synchronously on the devices and added devices. In step 360, the users end recording, and in step 365, videos are sent to the server through the Internet. In step 370, videos are distributed to other parties on the recording session through the Internet. In step 375, once the videos are received, they are processed to synchronize playback.

In an embodiment, the footage from each device that is in a group and/or recording session is being played back in a single frame, at the same time, with multiple windows on the master device users screen. The master device is for example displaying multiple screens of equal size frames and the master device user is viewing all recorded footage being played back at the same time. In an embodiment the master device user can pull recorded footage from across different devices and users in different groups or recording sessions. In an embodiment, when the master device is playing all frames at the same time, the audio being played back is that from the master device's recording.

In other embodiments, the master device user is using the app to choose which frame to play at any one time and can make decisions based on angle lighting and other factors that might affect the footage. In particular embodiments, the master device user is choosing one or more frames to play at any one time to show contrasting or correlating perspectives of a particular event. The user can also move the frames around on the screen and orient the frames and add or remove frames as desired.

In other embodiments, the master device user can choose a dominant frame and the system is displaying a more enlarged frame of the selected dominant frame compared to other frames on the screen that are showing the footage in smaller frames on the same screen. The user can move the smaller frames up into the dominant area of the screen to switch around which screen/s are being played back as the dominant screen. In particular embodiments, the audio that was recorded with the dominant frame is being played when the user selects a frame to be the dominant screen and changes when the user moves or selects another dominant screen to now play the audio attached to the newly selected dominant frame/screen.

In an embodiment, the system detects which frame is showing a highlight or most desired activity and plays back that frame as the dominant frame. The system uses pre set parameters to determine which frame is the desired frame, for example the system can track when a goal is being scored or a conflict is arising, in for example a sporting match, by the level of activity and movement in the frame. If there are multiple frames with detected movement, the app will display the relevant screens where the threshold and/or pattern of activity is detected. The app has an aspect ratio to adjust the size of each frame to fit the master device users screen based on the number of cameras/satellite device users are active in a recording session so that all frames a visible on each slide. The master device user can attach screens to their device if there are too many satellite device users to adequately view the footage on the single device screen. As the frames are being played back, there is a watermark feature that labels who the user is for each recording so that the master device user can see who is recording what footage. This also allows the master device user to communicate with particular users by sending them a message via the app for example by clicking into a message symbol on the frame.

In an embodiment, a user who is watching and/or playing back the recorded footage is swiping between multiple screens, from screen to screen, and/or from frame to frame, such that they are viewing the different perspectives and angles of the footage as the video is continuously rolling and/or paused at a point in time. For example, the user is viewing a particular frame that is being recorded or was recorded by a satellite user, and then swipes across the screen of the device to change the screen to show the frame of a different satellite user's recording. For example a user can pause the recorded footage then swipe across screens to see the same frame in another satellite user's recorded footage at the same point in time. A user can swipe multiple times to navigate between multiple different satellite users' recorded footage, either as the footage is being continuously played back or paused at a point in time, such that the different perspectives as recorded by each satellite user, is being displayed on the screen of the device and can showing different angles of the same event.

In an embodiment, while the footage is rolling a user can pause the footage that is being played back, and take a snapshot of the frame at which the video is paused. The user can use the frame at which the footage is paused to generate GIF file and upload to the giphy/imgur/9gag. In an embodiment, the user can generate the GIF file without pausing the footage and the system detects the users input and instruction by a click of a button to for example ‘capture this frame now’, and the system will generate the GIF at that frame.

In an embodiment, the user is able to retrofit previously recorded and/or archived recordings from the database or other storage source to be stitched together. In an embodiment, the system is using continuous or sections of audio samples attached to the video footage as recorded by the multiple satellite device recorded footage to aid in the synchronizing of timing for the video to merge them to multi-view playback. In an embodiment, multiple forms of editing are available to the user as the system stitches or connects the audio and video footage selected by the user to be stitched or connected together to form an edited continuous stream of footage. In an embodiment the system uses other parameters to synchronize the stitching or editing, such as time frame intervals and/or points, lighting, brightness, contrast, satellite user proximity and other related videography and audio elements known in the art.

In an embodiment, the satellite devices are recording audio and visual footage in slow motion. In an embodiment, the system detects the capabilities of each satellite device, either by tracking the camera and/or audio device on the satellite device and/or by recording the information registered by the user about their device during the registration process, to show a button that indicates the ability to recording footage in slow motion when the feature is enabled by the system. In an embodiment, the slow motion recording is enabled for only those satellite devices that show to have slow motion enabled. In an embodiment, the master device is playing back the recorded footage received from the satellite device in slow motion for example where the satellite device cannot record in slow motion.

In an embodiment, a user is set up as a satellite and/or secondary device user and is registering for an event, creating a user ID/name, recording session and/or group from a list of future events and/or recording sessions that is stored in the system. The list reflects groups and recording sessions created by master users and/or default groups created by the system administrator. In an embodiment, the satellite device user is accepting a recording session and updating their status before and during the recording session. The satellite device user is providing information about their availability, flexibility, device capabilities, battery power and camera specifications, by answering questions asking during registration. The master device user can view this information as a profile for each satellite device user.

In an embodiment, the satellite device user can grant and withdraw consent for the master device user to have automatic access to the recording feed as the satellite device user is recording footage. The satellite device user can store their own-recorded footage onto the satellite device and/or an external storage system and then send it to the master device and/or master device user at a later time. In an embodiment, the system automatically sends the footage to the master device and/or master user at predetermined times and intervals after the recording session has concluded. In an embodiment, the satellite device/s is recording the footage and the master device is directly accessing the recorded footage from the satellite device. In other embodiments the satellite device user is sending the footage to the master device via wireless communications and/or external cloud and server technologies. In an embodiment, the satellite device user can register as a master device user and create their own group and invite other devices similar to the master device and user. In an embodiment, the app interacts with GPS to allow tracking of the satellite device and the master device can view if the satellite device/s are moving around e.g. in side to outside, seat to seat, event to event.

In an embodiment, the system tracks and records participation and recording diligence of each satellite device user and provides a rating based on the performance of the recording provided by each satellite device. The ratings are generated and stored on the systems database based on the frequency on participation and quality of the recording of each recording session for each satellite device and user. In an embodiment, the system allows a master device user and/or administrator to offer fees to high performing satellite device users to be offered payment for a recording session. Satellite device users with VIP or special access zones to particular events may be offered higher rates. In other embodiments, highly rated satellite device users can post recording fees and have payments made to them by master device users.

In an embodiment, the system has a communication system such as Wi-Fi and Wi-Fi-direct that is interconnecting the devices and allowing the devices to send and receive recorded information and signals. In an embodiment, the system has memory that is temporarily receiving and storing recorded images and feed. The devices in the system are able to withhold the recorded feed that their individual device has recorded and/or send it to the master device user for editing and playback. In an embodiment, the system has GPS, so that the location of the devices can be determined in the system and used to map the location of all the devices in a recording session and/or group.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device (“PLD”) such as a Field-Programmable Gate Array (“FPGA”), Programmable Logic Array (“PLA”), or Programmable Array Logic (“PAL”), or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ 8 operating system, Microsoft Windows™ 7 operating system, the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims:

I claim:

1. A computer-readable, non-transitory programmable product, for recording and controlling video footage for a plurality of devices, comprising code executable by one or more processors, to cause the one or more processors to do the following:
cause a plurality of devices to record video;
cause the plurality of devices to transmit recorded video to a master device; and
cause the processing of the recorded video from the plurality of devices for playback.

2. The computer-readable, non-transitory programmable product as recited in claim 1 which further causes the processor of the master device to combine the video recordings, from the plurality of devices, on a plurality of areas of a split screen, each area being for a respective recording from an associated device.

3. The computer-readable, non-transitory programmable product as recited in claim 1 which further causes the processor of the master device to combine the video recordings, from the plurality of devices to be played back simultaneously in a single frame, on equally equal sized areas.

4. The computer-readable, non-transitory programmable product as recited in claim 1 which further causes the one or more processors to additionally do the following:
record audio from a plurality of devices; cause the plurality of devices to transmit recorded audio to a master device; and cause the processing of the recorded audio from the plurality of devices for playback.

5. The computer-readable, non-transitory programmable product as recited in claim 3 which further causes the processor of the master device to process the audio recordings, from the plurality of devices, for playback.

6. The computer-readable, non-transitory programmable product as recited in claim 1 wherein the programmable product provides a user controlled editor for choosing frames, from among the video provided by the plurality of devices, for playback.

7. The computer-readable, non-transitory programmable product as recited in claim 1 wherein the programmable product provides a user controlled editor for allowing the play back of multiple frames in a dominant area, while other video plays in other areas of a screen.

8. The computer-readable, non-transitory programmable product as recited in claim 1 wherein the programmable product provides a user controlled editor for allowing the play back of associated audio with the dominant area.

9. The computer-readable, non-transitory programmable product as recited in claim 1 wherein the programmable product causes the one or more processors to select an aspect ratio for recording in connection with each device.

10. The computer-readable, non-transitory programmable product as recited in claim 1 wherein the programmable product causes each device to watermark each recording according to an associated user.
